(19) United States
(12) Patent Application Publication
(10) Pub. No.: US 2026/0259180 A1
(43) Pub. Date: Sep. 3, 2026

(54) MEASUREMENT UNCERTAINTY AT ACQUISITION INSTANCE FOR NON-DESTRUCTIVE TESTING

(71) Applicant: Evident Scientific, Inc., Waltham, MA (US)

(72) Inventor: Julia G. MacDougall, Wilmington, MA (US)

(73) Assignee: Evident Scientific, Inc., Waltham, MA (US)

(21) Appl. No.: 19/549,853

(22) Filed: Feb. 25, 2026

Related U.S. Application Data
(60) Provisional application No. 63/765,257, filed on Feb. 28, 2025.

(51) Int. Cl. G01N 29/44; G01B 17/02; G01N 29/04

(52) U.S. Cl. CPC G01N 29/4454; G01B 17/02; G01N 29/04

(57) ABSTRACT

Various devices and methods for non-destructive testing (NDT) are provided. For example, an NDT testing system may include a sensor for acquiring measurement data, a user interface, and a control circuit. The control circuit may obtain the measurement data and generate a measurement result and a measurement uncertainty contemporaneously with the acquisition. The user interface may display the measurement result and the measurement uncertainty.

### CROSS REFERENCE TO RELATED APPLICATION

This application claims the benefit of priority under 35 U.S.C. § 119 (e) to U.S. Provisional Patent Application No. 63/765,257, filed on Feb. 28, 2025, the entire disclosure of which is hereby incorporated by reference in its entirety.

### BACKGROUND

### Technical Field

This document pertains generally, but not by way of limitation, to apparatus and techniques for non-destructive inspection such as facilitating mechanical inspection, and more particularly, to apparatus and techniques for performing automated or semi-automated compilation of descriptive statistical information for a series of measurements at the point of use, such as for presentation on a display of a non-destructive test (NDT) instrument.

### Discussion of Art

Non-destructive testing (NDT) can refer to the use of one or more different techniques to inspect regions on or within an object, such as to ascertain whether flaws or defects exist, or to otherwise characterize the object being inspected. Examples of non-destructive test approaches can include use of an eddy current testing approach where electromagnetic energy is applied to the object and the resulting induced currents on or within the object are detected, with the values of a detected current (or a related impedance) providing an indication of the structure of the object under test, such as to indicate the presence of a crack, void, porosity, or other inhomogeneity.

Another approach for NDT can include use of an acoustic inspection technique, such as where one or more electroacoustic transducers are used to insonify a region on or within the object under test, and acoustic energy that is scattered or reflected can be detected and processed. Such scattered or reflected energy can be referred to as an acoustic echo signal. Generally, such an acoustic inspection scheme involves use of acoustic frequencies in an ultrasonic range of frequencies, such as including pulses having energy in a specified range that can include values from, for example, a few hundred kilohertz, to tens of megahertz, as an illustrative example.

As an illustrative example, a material thickness can be gauged using a magnetic or acoustic (e.g., ultrasonic) technique. Such gauging can be used for characterization of material thickness such as supporting inspection for manufacturing or corrosion monitoring, as illustrative examples. A thickness gauge instrument can be a stand-alone instrument comprising a transducer, a display, and a user input. The stand-alone instrument may or may not include or be coupled with any storage facility for capturing measurement data and associated metadata (e.g., traceability information such as acquisition date, location, identifier of a workpiece or other object under test). Accordingly, in one approach, a user may be transcribing measurement information and associated metadata by hand either into a written log or an electronic device (e.g., a form) using hand entry of data.

### SUMMARY

In one aspect, the present disclosure provides a method of non-destructive testing. The method may include acquiring, by a sensor of a non-destructive testing (NDT) device, measurement data including a series of N measurements for a test location of an object. The method may include displaying, by a user interface of the NDT device, a measurement result and a measurement uncertainty for the test location. The measurement result and measurement uncertainty may be displayed in real-time contemporaneously with the acquisition of the measurement data.

In one aspect, the present disclosure provides for an NDT system. The NDT system may include a sensor, a control circuit, and a user interface. The sensor may acquire measurement data for a test location on or in an object. The control circuit may obtain the N data acquisitions from the sensor, process the measurement data to derive N measurement values for the test location, determine a sample mean and a sample standard deviation from the N measurement values, and generate a measurement result and a measurement uncertainty for the test location based on the sample mean and the sample standard deviation. The user interface may display the measurement result and the measurement uncertainty for the test location in real-time contemporaneously with the acquisition of the measurement data.

### BRIEF DESCRIPTION OF THE DRAWINGS

FIG. 1 is a block diagram of a non-destructive testing system, according to at least one embodiment of the present disclosure.

FIG. 2 illustrates an operator acquiring measurement data for a location of a test object using an NDT system, according to at least one embodiment of the present disclosure.

FIG. 3A-FIG. 3D illustrate user interfaces for displaying a measurement result and a measurement uncertainty, according to at least one embodiment of the present disclosure.

FIG. 4 is a flowchart of an example of a method for non-destructive testing, according to at least one embodiment of the present disclosure.

FIG. 5 is a block diagram of an example comprising a machine upon which any one or more of the techniques (e.g., methodologies) discussed herein may be performed, according to at least one embodiment of the present disclosure.

### DESCRIPTION

Non-destructive testing (NDT) generally includes inspection techniques that may assess an object's condition without altering or damaging the object. In various applications of NDT, an operator may be required to perform inspections point-by-point across a defined set of test locations on one or more test objects (e.g., ultrasonic inspection of piping, vessels, or plates). At each location, practical realities such as surface curvature, couplant quality and application, probe seating and pressure, environmental conditions (e.g., moisture, temperature), device gating and timing, and/or inherent variability of the test object can introduce measurement variation.

For point-by-point inspections across a defined set of test locations, an operator may position a sensor at one of the test locations, acquire one or more readings, and record one or more measurement values before moving on to the next location. When the operator returns to the same location after weeks or months for retesting, any difference between the newly reported value and the prior value can be difficult to interpret. For example, the change could reflect true material change (e.g., corrosion loss or crack growth) or merely measurement process variability (e.g., differences in probe orientation, couplant application, time gating of the measurement data, or surface condition of the test piece).

Some approaches attempt to address this by having the operator take multiple measurements at each test location to try to capture more context about measurement variability. However, these approaches often require exporting the collected data for offline statistical analysis, which can delay workflows and on-site decision making. For example, because measurement data is often processed after the on-site acquisition, these approaches can face challenges related to implementing on-site actions based on context derived from the measurement precision insights.

According to various embodiments, the present disclosure provides devices and methods for non-destructive testing that can provide real-time measurement results and corresponding measurement uncertainties contemporaneously with the acquisition of the measurement data. For example, a non-destructive testing system (e.g., instrument) may include a sensor, a control circuit communicably coupled to the sensor, and a user interface. The sensor may be operable to acquire measurement data for a test location of an object. Acquiring the measurement data may include acquiring a series of N measurements for the test location. The control circuit may generate a measurement result and a measurement uncertainty for the test location based on the measurement data, and may cause the user interface to display both the measurement result and the measurement uncertainty in real-time contemporaneously with the measurement data acquisition.

Displaying the measurement result and the measurement uncertainty in real-time contemporaneously with measurement data acquisition can mean that the measurement result and the measurement uncertainty are displayed as the measurement data is acquired or immediately after. For example, the control circuit may update the measurement result and corresponding uncertainty each time one of the N measurement values for the test location is acquired (e.g., without pausing acquisition or requiring offline processing). As another example, the control circuit may generate the measurement result and its uncertainty for the series of N measurement values for the test location immediately after the last measurement value of the series is acquired (e.g., before acquiring measurement data for a next test location).

Real-time display of the measurement result and uncertainty can improve repeatability and auditability by standardizing how precision is determined and reported across operators and sessions, while enabling richer records (e.g., including raw values, derived statistics, and metadata) for downstream comparisons and trending. For example, linking uncertainty thresholds to device behavior, such as prompting reacquisition, suggesting parameter adjustments, advancing to the next location when precision is acceptable, or instructing a robot to reposition, can optimize throughput without sacrificing data quality. In automated deployments, uncertainty thresholds can drive conditional branching, thereby embedding quality criteria into autonomous inspection routes and elevating the device from passively reporting single values to actively managing measurement acquisition quality.

According to various embodiments, the control circuit may process the acquired measurement data to derive N measurement values for the test location. For example, the control circuit may process signal data from the sensor corresponding to each of the series of N measurements to derive N measurement values for the test location. In ultrasonic implementations, each of the N measurements may yield an A-scan, and the control circuit may apply gates (e.g., start, width, and position), filters, and/or detection logic to identify target echoes, then convert time-of-flight to a measurement value. In other modalities, the control circuit may process the sensor signal to extract the relevant property (e.g., amplitude, phase, or other feature) as a measurement value.

The control circuit may generate the measurement result and measurement uncertainty based on determining a sample mean and a sample standard deviation over the N measurement values. The sample mean may represent the measurement result for the test location, and the sample standard deviation (optionally multiplied by a configurable factor, such as 2 for a 95% interval) may represent the measurement uncertainty. For example, the measurement result and uncertainty can be expressed as x̅±k·s, where x is the sample mean, s is the sample standard deviation, and k is a selectable multiplier.

Thus, according to various embodiments, a user can perform multiple acquisitions and associated measurements, such as acquiring multiple A-scans at a single test location. The instrument (e.g., the control circuit) can then use those A-scans to calculate a sample mean x̅ and sample standard deviation s and can report (e.g., via the user interface), for example, a thickness or flaw depth measurement and measurement uncertainty (x=x̅±2s) contemporaneously, to the user. In between respective individual measurements, the user could choose to keep the probe (e.g., sensor) in place or to remove and reapply the probe to the test piece (e.g., test object). On display or stored statistical parameter reporting can be an option that the user can select, rather than the default measurement reporting format, as an example.

In some implementations, with statistical parameter information, such as a measurement uncertainty parameter, the user can determine if the measurement has sufficiently high precision or low precision numerically (e.g., using a metric such as fractional uncertainty=2s/x̅) such as in the context of their specific application; a high precision measurement (e.g., no greater than 10% fractional uncertainty) increases confidence in the repeatability of, for example, a thickness/flaw depth measurement, while a low precision measurement (e.g., greater than 10% fractional uncertainty) indicates that the user may want to reexamine or optimize their measurement process.

This can provide similar guidance to users who are looking for flaw growth/thickness changes by gathering data at the same test locations over longer periods of time. While there are many external factors that could affect test location thickness/flaw depth measurements that are collected at the same test location but at different times (e.g., environmental conditions, probe wear and tear, test piece surface conditions, etc.), the precision of previous measurements at a given location can provide the user with additional information about that test location they would not have if only a single measurement is recorded by the user during a previous inspection. With this additional context, the user can make a more informed decision as to whether the flaw depth/thickness is changing over time or whether external factors are at work (or both).

It is likely that many users make multiple measurements at the same test location, but the present inventor has recognized that it is unlikely that the user records every individual measurement; instead, the user might generally report a single “best” representative measurement (e.g., thickness or flaw depth) for that location, resulting in the loss of the additional context the user gains from their knowledge of the repeated measurements. By having the instrument or associated processing facility tabulate and report a thickness/flaw depth measurement and measurement uncertainty to the user (possibly with the option to review or save the individual measurements or other data such as A-scan time series data) without any extra effort on the part of the user, the user can record the calculated measurement and measurement uncertainty (or another parameter indicative of, for example, measurement value dispersion) as well as more easily document any difficulties they encountered at that test piece location. This metadata may increase user confidence in the quality of the thickness/flaw depth measurement gathered at each test location. It also provides useful context to users revisiting previous test locations after considerable time has passed.

The NDT system may include various types of sensors. For example, in ultrasonic implementations, the sensor may be a contact or delay line transducer, a phased array probe, or a guided wave ultrasonic transducer connected to a portable thickness gauge or flaw detector. The NDT system (e.g., after device calibration) may acquire N waveforms (e.g., A-scans), apply user-defined gates to each waveform time series after identifying the target echoes, and extract N measurement values (e.g., wall thickness or flaw depth) using time-of-flight conversion based on a known acoustic velocity of the test material. In other implementations, the sensor may include eddy current probes (for conductivity or crack proxies), acoustic emission sensors, thermographic sensors, or other inspection sensors that measure properties such as signal attenuation, porosity proxies, or surface hardness. The statistical analysis and workflows described herein are modality-agnostic and can be applied to any type of sensor data that yields numerical measurement values.

In some embodiments, the control circuit may employ incremental algorithms to update aggregates (e.g., count, sum, and sum of squares) as measurements are acquired, enabling real-time computation of the mean and standard deviation without requiring large memory buffers. This approach can enable the device to efficiently process and display statistical results even with limited onboard resources, and to update the user interface dynamically as new measurements are acquired.

In certain embodiments, the control circuit may determine a fractional uncertainty based on a ratio of a multiple of the sample standard deviation to the sample mean. For example, the control circuit may compute (k·s)/x̅, where k is a multiplier (e.g., 2, 3, 4), and compare the fractional uncertainty to an uncertainty threshold. Expressing uncertainty in fractional form may normalize the tolerance to the magnitude of the measured property, making uncertainty thresholds portable across different measurement ranges and modalities.

In some embodiments, the user interface may receive a selection of an uncertainty threshold prior to acquisition. The uncertainty threshold may define a maximum allowed uncertainty for the measurement at the current location (e.g., a fractional uncertainty limit such as 10%). The user interface may receive the uncertainty threshold via operator input (numeric keypad entry, slider selection, or preset selection) or through loading job profiles provided by an asset owner. The control circuit may compare the generated measurement result and/or uncertainty to the uncertainty threshold and cause the system to automatically implement actions accordingly.

For example, based on the measurement uncertainty satisfying the uncertainty threshold (e.g., exceeding the uncertainty threshold), the user interface may automatically display a prompt to re-acquire measurement data for the same test location. The prompt can include recommended additional measurements (e.g., “Acquire five more readings”), controls to pace probe reapplications (e.g., countdowns or soft buttons), and/or indicators showing the current mean and standard deviation so the operator can observe precision in real-time.

According to some examples, the user interface may prompt the operator to modify one or more measurement parameters based on the measurement uncertainty satisfying the uncertainty threshold (e.g., exceeding the uncertainty threshold). Modified measurement parameters may include sensor or probe type/frequency, gate placement and timing, gain, excitation (pulser) level, filtering options, and/or couplant application. The prompt can present a checklist (e.g., “verify probe seating/pressure,” “reapply couplant,” “confirm gate alignment to back wall echo,” “consider lower frequency for curved or attenuative surfaces”) for implementing adjustments according to defined inspection standards. Additionally, or alternatively, the control circuit may automatically modify one or more measurement parameters of the NDT system based on the uncertainty satisfying the threshold.

Based on the measurement uncertainty satisfying the uncertainty threshold (e.g., being below the uncertainty threshold), the control circuit may automatically transition into an acquisition state for the next test location of the object. For example, if the measurement uncertainty is acceptable relative to the uncertainty threshold, the control circuit may automatically increment a location identifier (e.g., from a current ID to the next ID), pre-load the same settings or profile, and/or re-arm the acquisition logic for efficient point-to-point workflows.

In some embodiments, the NDT system may include a robot, robotic arm, or other mechanical means (e.g., motors, carriages, rail systems) for automatically moving the sensor to testing locations. Based on the measurement uncertainty satisfying the uncertainty threshold (e.g., being below the uncertainty threshold), the control circuit may automatically cause a robot, robotic arm, or other mechanical means to reposition the sensor to a next test location. The control circuit may issue motion commands to a robot, robotic arm, or other mechanical means to retest the current location until precision improves or to advance when acceptable (e.g., implementing a conditional decision tree that encodes measurement quality criteria into autonomous inspection routes).

The control circuit may exclude invalid measurement values from statistical calculations. For example, the control circuit may implement rules that identify and exclude invalid measurements such as loss of signal, misdetections, and/or stability violations. The user interface may identify excluded values in context (e.g., using markers in a chart or annotations like “excluded due to loss of signal”), providing transparency about data quality while keeping the uncertainty determination robust to outliers or failures.

In various embodiments, the user interface may display a graphical representation of the distribution of the N measurement values, such as a histogram (showing bin counts across the range) or a probability density curve parameterized by the sample mean and standard deviation. These visualizations may update in real-time as each new measurement value is added and/or after each set of N measurements is acquired for a particular test location.

A memory may be coupled to the device to store the N measurement values, the measurement result, the measurement uncertainty, and/or metadata associated with the acquisition. The metadata may include device control settings and/or a test location identifier (e.g., grid index, coordinates, barcode or RFID tag). The metadata may include user annotations for selected measurement values via the user interface, such as pick-list tags (“couplant issue,” “surface roughness,” “good measurement,” “unknown anomaly”) or free-text notes. This data storage can support traceability, audit requirements, and/or future comparison of measurement data for corresponding test location.

In various embodiments, the control circuit may compare the current measurement result and uncertainty to previously stored values for the same test location. The user interface may indicate whether the current uncertainty exceeds a prior measurement uncertainty and/or whether the respective intervals (e.g., mean±2·standard deviation) overlap. This comparison to the prior measurement results and uncertainty can assist operators and asset owners in interpreting whether observed changes reflect process variability or material change. Based on this comparison, the control circuit may prompt the operator to retest the test location, flag the location for further review, or automatically generate a report highlighting locations with significant changes or increased uncertainty.

In some embodiments, a remote server may be communicably coupled to the sensor of the NDT system via a network. The remote server may comprise the control circuit or otherwise be communicably coupled to the control circuit. For example, the control circuit (e.g., via a wireless transceiver, Ethernet port, or other communication hardware) may stream measurement data to the remote server. The remote server may generate and transmit a measurement result and corresponding measurement uncertainties in real-time, contemporaneously with acquisitions at particular testing locations (e.g., for display via the user interface). The remote server can enable centralized computation, standardized thresholds across fleets, and integration with enterprise asset management systems.

The measurement result may define a property of the object at the test location, such as material thickness, flaw depth, crack length, porosity level, corrosion loss, surface hardness, or a signal attenuation metric. For example, in ultrasonic implementations, the measurement result may represent wall thickness or flaw depth. In eddy current implementations, the measurement result may represent conductivity or crack length. In thermographic or acoustic emission implementations, the measurement result may represent porosity, surface hardness, or attenuation. The measurement result and measurement uncertainty determinations may be modality-agnostic so long as the sensor yields repeatable numerical values.

In some embodiments, the user interface may prompt removal and reapplication of the sensor between successive acquisitions for the series of N measurements. Removal and reapplication of the sensor may decorrelate consecutive readings and reveal location-specific variability that might be concealed if the probe is held stationary. Removal and reapplication of the sensor may provide the user with multiple opportunities to improve probe seating and refresh couplant as needed.

In some embodiments (e.g., in a portable NDT UT product), users may be provided with the option to take multiple measurements at the same test location and provide (e.g., the user interface may display) a statistical summary of those measurements.

According to various example use cases, the devices and methods provided herein can provide users and stakeholders with a sense of measurement precision, repeatability, and/or robustness. If statistical analysis indicates that a measurement has low precision, users are made aware that they may be able to increase the measurement precision by modifying the measurement process for a specific application.

Adjustable components (e.g., for modifying the measurement process) can include probe and frequency selection; device parameters (e.g., voltage, gain, mode selection, gate positioning, etc.); couplant application (e.g., more/less couplant needed (e.g., on a delay line, on a test piece, etc.); choice of measurement location on the test piece (e.g. on test pieces where the thickness is not changing rapidly) consistency, amount, and/or angle of pressure applied to probe by user.

For measurements gathered at the same location over long periods of time, users may be able to more easily identify significant thickness/flaw depth changes as those falling outside the measurement uncertainty range of previous measurements.

In some embodiments, the statistical analysis techniques discussed herein may be applied to portable UT devices. Confidence in validity of the statistical analysis can be enhanced when the following assumptions can be made: (i) the same processes and components are present for each measurement throughout the duration of the statistical analysis technique measurement process (e.g., the user is utilizing the same probe (model and serial #), couplant, and cable when taking multiple measurements of the same spot on the same test piece; and (ii) possible sources of error are random in nature (and, therefore, the sum of those error sources also produces a random probability distribution). In some implementations, it may be assumed that the errors produced by the measurement process are random (e.g., because if they weren't, the user would likely observe something awry with the A-scan).

In some embodiments, the following example workflow may be implemented. A user may select a number of measurements the user would like to make of the same spot (e.g., between N=5-20 measurements per testing location, depending on how much time, patience, and planned test locations the user has). While this relatively low number (e.g., N=5-20) of measurements may not qualify as statistically significant, more measurements may correspond to a more accurate initial estimation of the underlying probability density curve described by the sample mean x̅ and sample standard deviation s.

The user may collect an initial measurement (not included in the N measurements) and apply the appropriate gate(s) and A-scan settings (e.g., gain, filters, pulser voltage, etc.) so that the device knows which A-scan features to measure in the N measurements.

The user may collect the N measurements from the same spot on the test piece (e.g., via the sensor). The user may completely remove the probe from the test piece in between each measurement.

The user may be presented with the option (e.g., via the user interface) to cause the device (e.g., the sensor) to start collecting each measurement (e.g., by providing an input to the device), such as by pressing a button on the device (e.g., the user interface) each time the user is ready to collect a measurement. As another option, an automatic countdown with distinct measurement intervals may be implemented (e.g., via the control circuit and user interface) so that the user can just lift and replace the probe (e.g., sensor) when directed by the device (e.g., user interface).

The user may be presented with two options: “single point” and “multiple points” (e.g., via the user interface). A “single point” option may involve the user taking N measurements at a single test location, and generating a statistical analysis using those N measurements sampling that specific test location. A “multiple points” option may involve the user taking N measurements, at various test locations within a small test area and generating a statistical analysis using the measurements collected from the N nearby points on the test piece.

The user may or may not choose (e.g., via a user interface selection) to display each of the N A-scans as they are collected.

Once the N measurements have been collected, the technique (e.g., the workflow) can include calculating (e.g., via the control circuit) the sample mean x̅ and sample standard deviation s and presenting (e.g., via the user interface) the user with the x=x̅±2s measurement and measurement uncertainty. If any of the N A-scans were defined by a LOS (e.g., loss of signal) or some other measurement failure, that information may be conveyed to the user (e.g., via the user interface) and the x=x̅±2s measurement may be calculated using only the A-scans for which a valid measurement was recorded. The user may or may not choose (e.g., via the user interface) to display a plot of the normal probability distribution that is described by x̅ and s.

In some embodiments, the control circuit may implement one or more automated signal quality checks to identify whether a given acquisition is characterized by a loss of signal or by poor signal quality. For example, the control circuit may monitor one or more parameters related to an acquisition (e.g. amplitude, signal-to-noise ratio) and may classify a measurement as invalid when the one or more monitored parameter(s) satisfy a determined threshold. Upon detecting such a loss of signal or poor signal quality condition, the control circuit may automatically exclude the corresponding measurement value from the calculation of the sample mean and sample standard deviation.

In other embodiments, the control circuit may detect a potential loss of signal or poor signal quality condition based on one or more monitored parameters related to an acquisition (e.g. amplitude, signal-to-noise ratio) and, upon satisfying a determined threshold (e.g., falling short of an established signal quality metric), generate a notification flagging the measurement for a potential loss of signal or poor signal quality condition. This notification may cause the device to request a user input (e.g., via the user interface) regarding whether to retain or remove the affected measurement. The user interface may receive a user input indicating removal of the flagged measurement, and the control circuit may then exclude that measurement from the calculation of the sample mean and sample standard deviation.

The user may have the option (e.g., via the user interface) to view/save the N A-scans that the device used to generate the measurement and measurement uncertainty values. For those using the instrument as a measurement data logger, the device could save both the individual thickness/flaw depth measurements and the calculated measurement and measurement uncertainty. Furthermore, if the user chooses to review the individual measurements and/or A-scans, the user may select a brief description of each thickness/flaw depth measurement, such as from a pick list (e.g., via the user interface). Possible options from the pick list could include “couplant issue”, “surface roughness issue”, “unknown issue”, “good measurement”, “bad measurement”, etc. This metadata could be useful to those reviewing the data, as well as for someone returning to measure the same test location after some time has passed, or for use for other purposes as labeled acquired measurement data.

The user may have the option (e.g., via the user interface) to discard statistical analysis technique results. For example, if a low precision measurement and measurement uncertainty is reported to the user, the user could choose to run the statistical analysis technique again after addressing an issue identified in the measurement process.

The x=x̅±2s measurement and measurement uncertainty reported by the device can provide valuable insight to the user. If the measurement uncertainty (=2s) is considered small with respect to both the x̅ value (e.g., its fractional uncertainty=2s/x̅ value is relatively low) and the specific application requirements, then user confidence in the measurement increases. If the measurement uncertainty is relatively large, then the user now has some indication that there may be issues or complexities in the measurement process and/or the test piece. If one or more aspects of the measurement process are contributing to the large measurement uncertainties, then the user may be able to identify and address those issues.

Potential explanations for larger measurement uncertainties may include but are not limited to: probe issues (e.g., probe type/frequency is not very sensitive to the thickness/flaw depth, probe is not flat on the surface, probe surface has experienced wear and tear, etc.); pressure applied to probe (e.g., user provides too little pressure when applying the probe to test surface); probe coupling to the test piece (e.g., too little or too much couplant is present on the test piece and/or the delay line, or some debris is present in the couplant or on the test piece surface); device settings (e.g., gate locations, pulse voltage, A-scan filter, A-scan gain); test piece surface conditions (e.g., pronounced surface roughness contributes to measurement variation); and/or test piece internal conditions (e.g., the test piece has structural complexities and/or the wall thickness varies rapidly over a small length scale).

If the user is measuring the thickness/flaw depth at a specific location over time, then insight into the individual measurements and the calculated measurement and uncertainty range (=x̅±2s) for each time period could make thickness changes over time more apparent.

In some embodiments, statistical analyses of thickness/flaw depth can involve extracting measurement values from multiple waveforms; including more waveforms in the analyses may increase the accuracy of the statistical estimates. For a given statistical analysis, the device may acquire N waveforms, where N>1 (e.g., N>>1).

For each of the N waveforms (n=1 to N), a thickness measurement/flaw depth (xₙ) may be measured. The sample mean x̅ may be the average value of the thickness measurement/flaw depth over all N waveforms:

$$\overline{x} = \frac{1}{N} {{\sum }_{n = 1}}^{N} {x}_{n}$$

The sample standard deviation s can summarize how the xₙ values are distributed around the sample mean x̅. Smaller s values can indicate that most of the N measurements are very similar to the calculated sample mean (indicative that there is high measurement precision) while larger s values can indicate that many of the measurements are distinctly different from the calculated sample mean (indicative that there is low measurement precision).

The sample standard deviation may be defined as:

$$S = \sqrt{\frac{{\sum }_{n = 1}^{N} {( {x}_{n} - \overline{x} )}^{2}}{N - 1}}$$

When gathering multiple measurements of the same phenomenon (e.g., at the same test location), one way to visually summarize the results is to use a histogram. A histogram can break an entire data set down into a series of intervals (or bins) and allows the user to visualize how many data points from the data set fall into each interval. The x-axis may be defined by the bin values and the y-axis may be defined by the number of occurrences in each bin. In a histogram, each bin has the same width, but different histograms of the same data set may be generated by changing the bin width and the number of bins.

An alternate approach to visualizing this data would be to use the calculated sample mean and sample standard deviation to generate a probability distribution curve for this random data. The sample mean x̅ and the sample standard deviation s are two statistical parameters that may describe a normal probability distribution curve. The normal probability distribution curve (e.g., also known as a Gaussian curve or a bell curve) describes the probability distribution of real-valued random variables. That is, if the phenomenon being measured can be described as a random process and it is sampled many times, the shape of the data may be described by a normal distribution curve. Many phenomena, both natural and not, are stochastic, and these phenomena can be accurately summarized using a normal distribution curve. The sum of multiple random processes also produces a normal probability distribution (e.g., a propagation of errors that occur when a device is used to acquire an A-scan). In statistical theory, the “true” probability distribution curve may only be realized after the phenomenon has been sampled infinitely many times. While infinite sampling may be impossible in real life, having more data will likely result in a probability distribution curve that more accurately represents the actual random processes being sampled.

The equation for the normal probability density curve is shown below, where f(x) is the probability density curve defined over a range of sample values x, x̅ is the sample mean, s is the sample standard deviation, and e (≈2.178) is a mathematical constant that represents a base of the natural logarithm:

$$f ( x ) = \frac{1}{\sqrt{2 π {s}^{2}}} {e}^{\frac{- {( x - \overline{x} )}^{2}}{2 {s}^{2}}}$$

Statistical significance may generally increase with more observations. The raw data and the probability density curve may not represent the same information; while the raw data is a strict reporting of the numbers involved, the probability density curve can provide a visualization of the data distribution that would arise if many more samples were acquired. At large values of N, the shape of a histogram will approach the shape of the normal probability distribution for a phenomenon that can be described by one or more random processes.

The sample mean can represent the peak of a normal probability density curve and the sample standard deviation can describe the width of the part of the curve that is centered on the sample mean. A common way of statistically summarizing the measurement and measurement uncertainty is x=x̅±2s because ~95% of the measurements that define a normal probability density curve fall in the=x̅±2s interval.

Results of the statistical analysis of a series of thickness/flaw depth measurements from a portable UT device may be analyzed based on the principles above. For example, if a user is collecting N thickness/flaw depth measurements from the same test location (e.g., N=5-20), then the calculated x̅ and s values may represent an estimate of the normal probability density curve that describes the sum of the random processes impacting the measurement process and test part conditions at that point in time (e.g., surface conditions, probe conditions, device conditions, environmental conditions, test piece conditions, etc.).

In some embodiments, calculated x̅ and s values may be used to make general statements about (e.g., may be indicative of) the precision of the thickness/flaw depth measurement at that specific location. For example, if a user collects N=10 measurements at the same test location and the statistical analysis technique (e.g., by the control circuit) generates a measurement result and measurement uncertainty of 0.38″±0.05″ (=x̅±2s, where x̅=0.38″ and s=0.025″), then the user may conclude that the combination of the measurement process and the test piece conditions result in a relatively high measurement precision. If the measurement result and measurement uncertainty is 0.41″±0.18″ (=x̅±2s, where x̅=0.41″ and s=0.09″), then the fractional uncertainty of the measurement has more than tripled compared to the previous example (0.05″/0.38″=0.13, 0.18″/0.41″=0.44) and the measurement precision is lower than that of the first example. With this less precise result, the user can be prompted (e.g., via the user interface) to check the integrity of the measurement process by measuring a known sample standard, to glance through the N=10 A-scans that were collected to identify instances of poor signal quality and/or A-scan feature variability, or to examine the test piece to determine if there are any visible causes for the measurement variability. In this case, the statistical analysis technique may provide a gut check for the user about the measurement repeatability that the user may not have if the user made a single measurement at this test piece location.

If the user is conducting long-term testing of the same test piece location(s) to identify places where the wall thickness/flaw depth has changed over time, the interpretation of the statistical analysis technique can become more difficult because there are many more possible sources of uncertainty. For example, in some scenarios, it may not be likely that the exact same probe and cable will be used to collect the measurements at the same location every six months. Even if the same probe/cable combination was used from one measurement period to the next, it is likely that the probe and the cable could experience wear and tear that could affect the thickness measurements. Furthermore, the environmental factors and test piece surface conditions can change within a six-month period. In conventional approaches, it is often up to the user to decide if a significant change in the thickness measurement is caused by the net effect of these external factors, if the pipe wall thickness has decreased over time, or some combination of the two.

For example, two thickness measurements from the same test location, Data 1 and Data 2, may be collected six months apart (with Data 1 being collected six months before Data 2). In Table 1 below, HP=high precision (e.g., small fractional uncertainty), LP=low precision (e.g., large fractional uncertainty), O=overlap (e.g., the measurement uncertainty intervals x̅±2s of Data 1 and Data 2 largely or entirely overlap one another), and NO=no overlap (e.g., the measurement uncertainty intervals x̅±2s of Data 1 and Data 2 are mostly or entirely separate from one another).

TABLE 1
Insights Based on Measurement Uncertainty for Multiple Data Sets
Collected at the Same Testing Location

| | Data 2, HP NO | Data 2, HP O | Data 2, LP NO | Data 2, LP O |
|---|---|---|---|---|
| Data 1, HP | Possible | Thickness | Possible | Possible |
| | thickness | change | thickness | thickness |
| | change | unlikely | change | change |
| Data 1, LP | Possible | Possible | Possible | Possible |
| | thickness | thickness | thickness | thickness |
| | change | change | change | change |

When Data 1 is low precision, it may be more difficult to quantify possible thickness changes using Data 2 because the measurement variability of Data 1 makes it difficult to be confident about the “true” Data 1 thickness value. Even if Data 2 is a high precision result that falls within the wider uncertainty range of Data 1, it is possible that the “true” thickness of the piece fell in another part of the Data 1 uncertainty interval that is not covered by the Data 2 uncertainty interval, which would imply that a thickness change had occurred between Data 1 and Data 2. The same logic may apply when Data 2 is low precision. In this example, the only case where it is likely that the test piece has experienced little to no change in the thickness is when both Data 1 and Data 2 are high precision measurements with measurement uncertainty intervals that overlap. Users that are conducting long-term test piece thickness/flaw depth measurements are likely to eventually accrue more than two data points for a given test piece location. Thickness/flaw depth trends over time may therefore provide the user with more insight into the test piece condition. In this scenario, the statistical analysis techniques discussed herein can provide useful information about the precision of each set of measurements that the user can consider when determining if thickness changes have occurred at a test location. The statistical analysis techniques discussed herein can provide the user with more context than they would have had if the user had merely measured each test piece location once before moving onto the next test location.

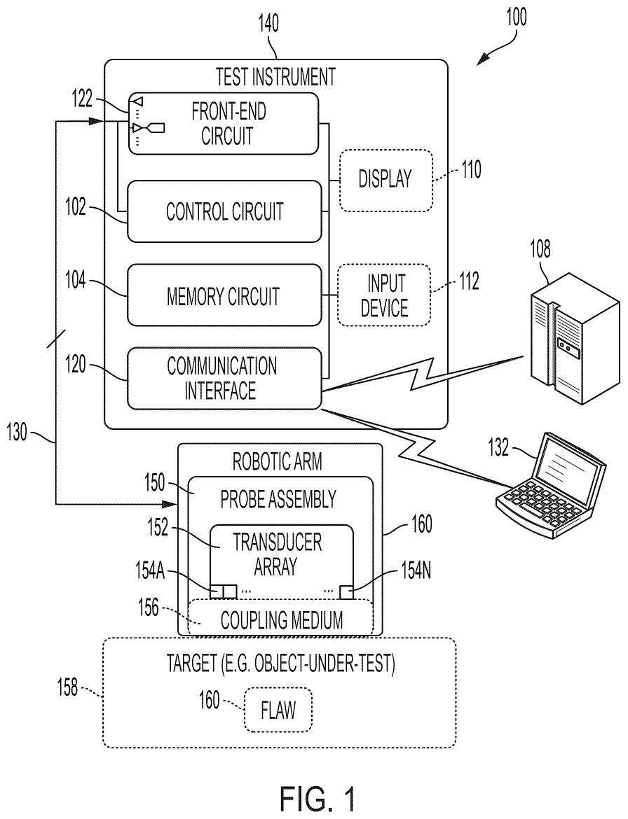

FIG. 1 illustrates an example implementation of an NDT system 100. Aspects of the NDT system of FIG. 1 may be combined with and/or employed to execute any of the other embodiments of the NDT system and/or methods disclosed herein, and vice versa.

The NDT system can include a test instrument 140, such as a hand-held or portable system. Example implementations of the test instrument may include a digital ultrasonic thickness gauge, a flaw detector, or a multi-modal NDT device capable of supporting various sensor types for field inspections. The test instrument can be electrically coupled to a probe assembly 150, such as using a multi-conductor interconnect 130. The probe assembly can include one or more electroacoustic transducers (e.g., sensors), such as a transducer array 152 including respective transducers 154A through 154N. The transducer array can follow a linear or curved contour or can include an array of elements extending in two axes, such as providing a matrix of transducer elements. The elements need not be square in footprint or arranged along a straight-line axis. Element size and pitch can be varied according to the inspection application. For example, the probe assembly may be modular, allowing the test instrument to be used with different probe types for different inspection applications, such as phased array probes for advanced imaging or single-element probes for thickness gauging.

In some examples, the transducer array may be acoustically coupled to a target 158 (e.g., a test specimen or “object-under-test”) through a coupling medium 156. The coupling medium can include a fluid (such as water or oil), a gel (such as ultrasonic couplant gel), a solid membrane (e.g., elastomer or polymer), or combinations thereof. For example, a probe assembly may include a transducer array mounted to a wedge structure made of a rigid thermoset polymer, with water injected between the wedge and the test object to serve as the coupling medium. Alternatively, the probe assembly and target may be immersed in a coupling medium during inspection, or a solid membrane may be used for contact inspections. The probe assembly may also be configured for eddy current, thermographic, or acoustic emission sensing, depending on the inspection modality.

The test instrument can include digital and analog circuitry, such as a front-end circuit 122 including one or more transmitter signal chains, receiver signal chains, or switching circuitry (e.g., transmit/receive switching circuitry). The transmitter signal chain can include amplifier and filter circuitry, such as to provide transmit pulses for delivery through the interconnect to the probe assembly for insonifying the target, such as to image or otherwise detect a flaw 160 on or within the target structure by receiving scattered or reflected acoustic energy elicited in response to the insonification. In some implementations, the transmitter and receiver chains may support multi-channel acquisition for phased array imaging or simultaneous multi-probe operation.

While FIG. 1 shows a single probe assembly and a single transducer array, other configurations can be used, such as multiple probe assemblies connected to a single test instrument, or multiple transducer arrays used with a single probe assembly or multiple probe assemblies for pitch/catch inspection modes. Similarly, a test protocol can be performed using coordination between multiple test instruments, such as in response to an overall test scheme established from a master test instrument or established by another remote system such as a compute facility 108 or general-purpose computing device such as a laptop 132, tablet, smart-phone, desktop computer, or the like. The test scheme may be established according to a published standard or regulatory requirement and may be performed upon initial fabrication or on a recurring basis for ongoing surveillance, as illustrative examples. For example, the NDT assembly may be integrated into a networked inspection system, where measurement data and statistical analysis results are transmitted to a remote server or enterprise asset management platform for centralized review and reporting.

The receiver signal chain of the front-end circuit can include one or more filters or amplifier circuits, along with an analog-to-digital conversion facility, such as to digitize echo signals received using the probe assembly. Digitization can be performed coherently, such as to provide multiple channels of digitized data aligned or referenced to each other in time or phase. The front-end circuit can be coupled to and controlled by one or more processor circuits, such as a control circuit 102 included as a portion of the test instrument. The control circuit can be coupled to a memory circuit 104, such as to execute instructions that cause the test instrument to perform one or more actions such as acoustic transmission, acoustic acquisition, processing, or storage of data relating to an acoustic inspection, or to otherwise perform techniques as shown and described herein.

For example, the control circuit may execute algorithms for real-time determination of the measurement results and the corresponding measurement uncertainties. During operation, the control circuit may collect a series of N measurements at a test location by repeatedly acquiring digitized echo signals from the probe assembly. For each acquisition, the control circuit may process the signal data to derive a measurement value, such as wall thickness or flaw depth, using techniques like time-of-flight analysis, gating, filtering, and detection logic.

As the N measurements are acquired, the control circuit may incrementally compute statistical parameters, including the sample mean and sample standard deviation of the measurement values. These parameters may be updated in real-time as each new measurement is added, allowing the device to efficiently process and display statistical results without requiring large memory buffers. The control circuit may then generate a measurement result (e.g., the sample mean) and a measurement uncertainty (e.g., a multiple of the standard deviation), and cause the display to present these values contemporaneously with the acquisition process (e.g., either updating the display after each measurement or immediately after the last measurement in the series).

In some embodiments, the control circuit may further determine a fractional uncertainty by calculating the ratio of a multiple of the sample standard deviation to the sample mean (e.g., 2s/x̅) and compare this fractional uncertainty to a user-defined or pre-set threshold. If the fractional uncertainty meets or exceeds the threshold, the control circuit may implement automated actions, such as prompting the user to re-acquire measurements, providing instructions to adjust measurement parameters (e.g., probe type, gain, gating, couplant application), or automatically entering a testing mode for additional data collection. If the uncertainty is below the threshold, the control circuit may automatically transition the device into an acquisition state for the next test location, incrementing the location identifier and preparing the system for continued inspection.

These real-time processing and decision-making capabilities can enable the NDT system to provide immediate feedback on measurement quality, support on-site optimization of inspection procedures, and/or facilitate automated or semi-automated workflows, including integration with robotic positioning systems or remote data processing facilities.

The test instrument can be communicatively coupled to other portions of the system, such as using a wired or wireless communication interface 120. This may include Ethernet, Wi-Fi, Bluetooth, or cellular connectivity for data exchange with remote servers, cloud platforms, or other devices. In some implementations, statistical analysis and/or uncertainty determination may be performed on-board the test instrument or may be distributed across remote processing or storage facilities such as a compute facility or general-purpose computing device.

For example, the test instrument may acquire a series of N measurements at a test location using the probe assembly, process the acquired measurement data to derive measurement values (e.g., thickness, flaw depth), and compute statistical parameters such as sample mean and standard deviation. Alternatively, these processes may be performed remotely (e.g., by a server at a remote compute facility) in response to a request from the test instrument. Storage of imaging data, A-scan time series, or other intermediate data may also be accomplished using remote facilities.

The test instrument can include a display 110, such as for the presentation of configuration information or results, and an input device 112 such as including one or more of a keyboard, trackball, function keys or soft keys, mouse-interface, touch-screen, stylus, or the like, for receiving operator commands, configuration information, or responses to queries. The display may present the measurement results and the corresponding measurement uncertainties in real-time, as well as graphical representations such as histograms or probability density curves. The input device may allow the operator to set uncertainty thresholds, respond to prompts for reacquisition or parameter adjustment, and annotate measurement data.

In some embodiments, the NDT system may include a robotic arm 160. The robotic arm may be operable to position the probe assembly at designated test locations on the object-under-test, either under operator control or autonomously. For example, the robotic arm may receive motion commands from the processor circuit or from a remote compute facility, enabling automated scanning of complex geometries, repeatable positioning for high-precision measurements, or rapid inspection of large structures. The robotic arm may be integrated with the test instrument to enable closed-loop inspection workflows, where measurement uncertainty is evaluated in real-time and the robotic arm is instructed to re-acquire data, adjust probe orientation, or move to the next test location based on precision criteria. This integration supports advanced inspection protocols, such as adaptive scanning, conditional branching, and autonomous data collection, as described in the present disclosure.

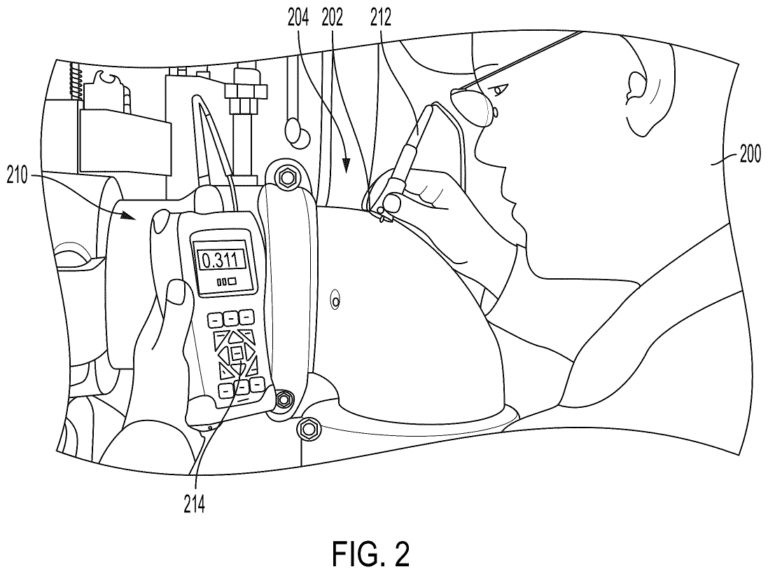

FIG. 2 illustrates an operator 200 acquiring a series of N measurements for a test location 202 of a test object 204. The operator is using an NDT system 210 that includes a sensor 212 and a user interface 214. Aspects of the NDT system of FIG. 2 may be combined with and/or employed to execute any of the other embodiments of the NDT system and/or methods disclosed herein, and vice versa.

The sensor may be positioned at the test location to acquire measurement data (e.g., a series of N measurements) to determine measurement values such as thickness, flaw depth, or other relevant properties of the test object. The user interface may present measurement results and related information to the operator, such as displaying individual measurement values, statistical summaries, or prompts for further action.

The NDT system may further include a control circuit, which may be operated to process the acquired measurement data, compute statistical parameters (such as the sample mean and standard deviation), determine measurement uncertainty, and/or cause the user interface to display results in real time. The control circuit may also compare measurement uncertainty (e.g., fractional uncertainty) to an uncertainty threshold, implement automated actions (such as prompting for measurement reacquisition or adjustment of measurement values) based on the comparison, and/or store measurement data and metadata for future reference or analysis.

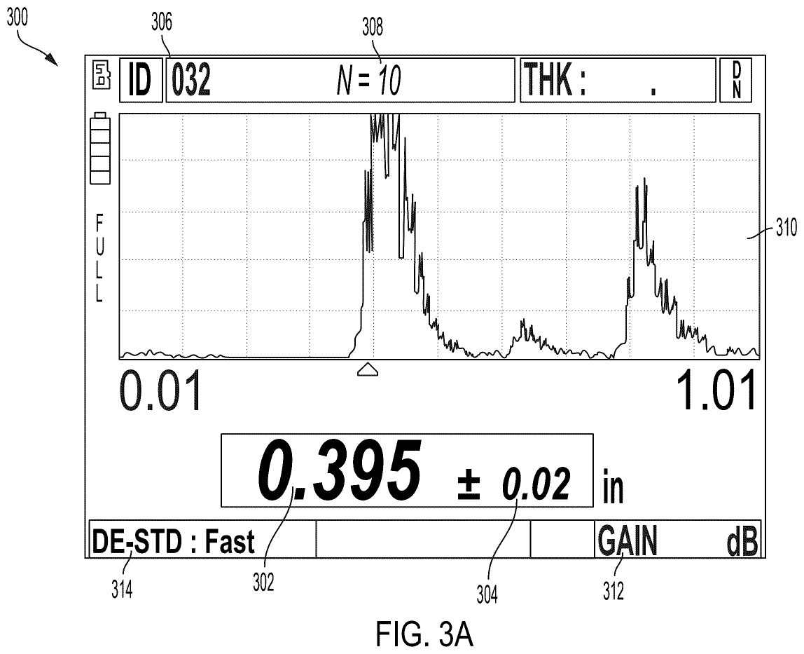

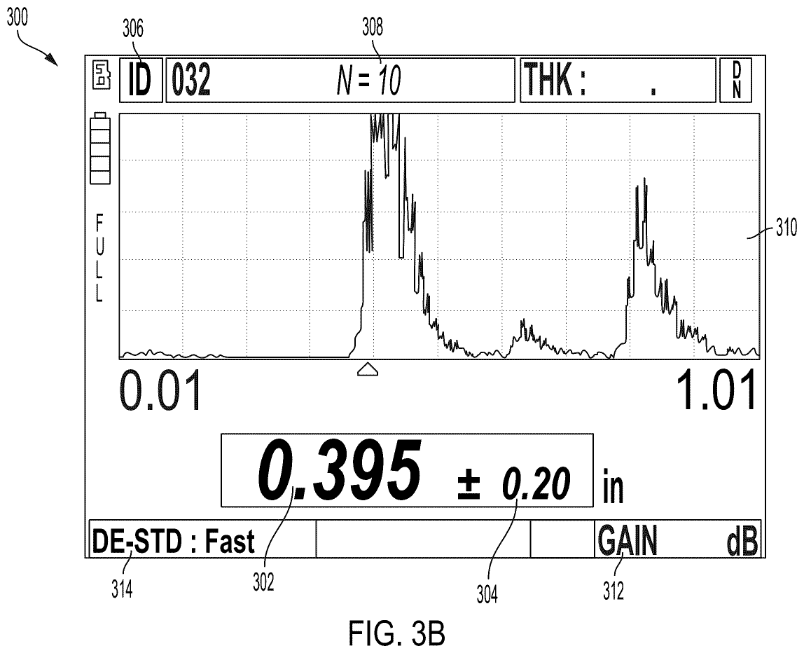

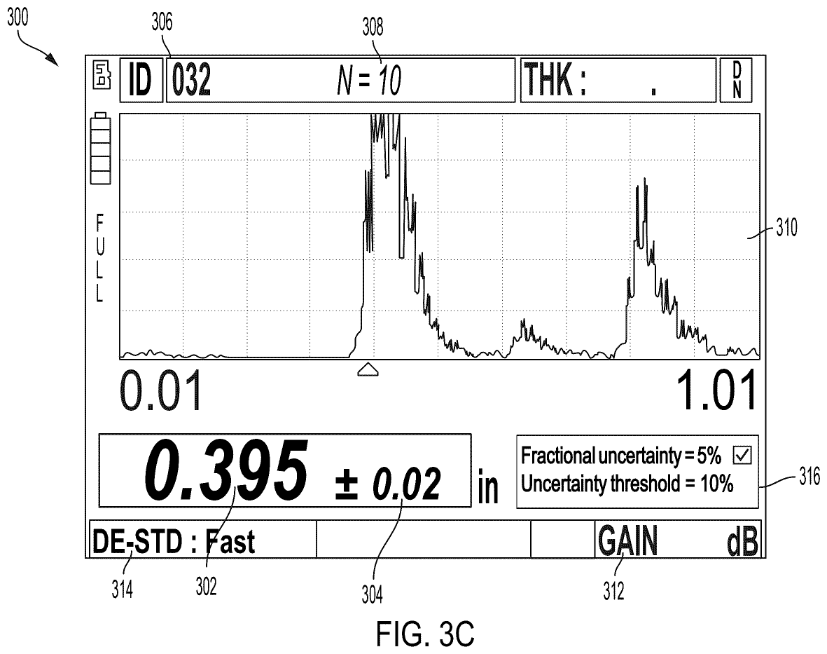

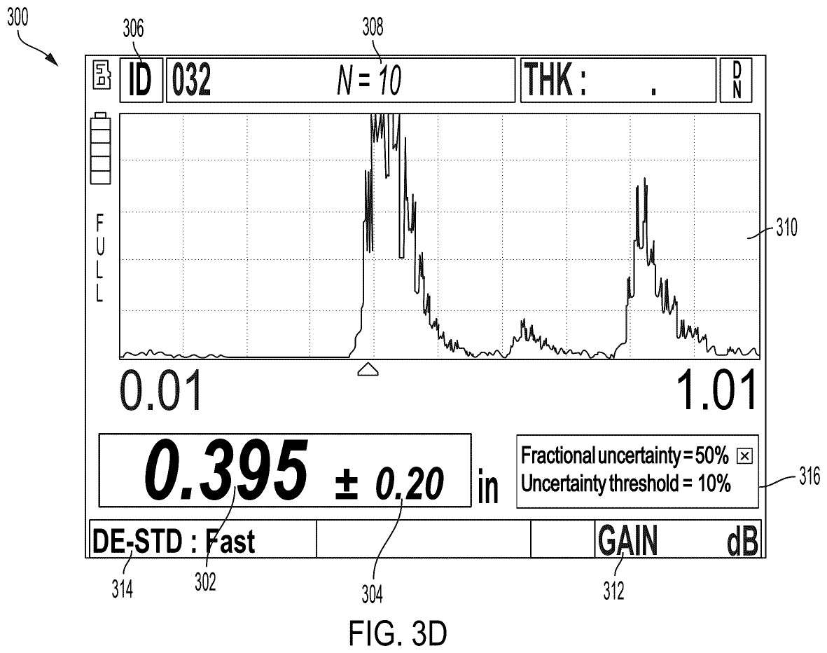

FIGS. 3A-3D illustrate example user interfaces 300 for displaying a measurement result 302 and a measurement uncertainty 304. The user interfaces may be included in any of the embodiments of the NDT system disclosed herein. For example, the user interfaces may be displayed via a display screen of an NDT system.

The user interfaces of FIG. 3A-3D include a test location identifier 306 (e.g., showing test location ID 32) and sample size indicator 308 (e.g., designating N=10 measurements values for the test location). The test location identifier can serve as a unique identifier for a particular test location that is being measured and analyzed. Measurement data, metadata, and/or analysis results may be stored based on the identifier (e.g., indexed, tagged). The sample size indicator displays the number of measurements to be acquired at the location. The sample size indicator may be defined by the user via the user interface.

Additional information may be presented in the user interfaces, such as a chart 310 that visually represents the acquired ultrasonic signal (e.g., an A-scan waveform). This chart may show the amplitude of received echoes as a function of time, with features such as gates or markers indicating the region used for measurement extraction. Gain 312 may refer to the amplification setting applied to the received signal, which can affect the visibility of echoes and the accuracy of the measurement extraction. A setting designated as DE-STD 314 may indicate a device configuration or standardization mode, such as a preset for measurement parameters, gating, or calibration, ensuring consistency across measurements and locations.

In each of FIGS. 3A-3D, the displayed measurement result is the same (e.g., 0.395 in). However, in FIG. 3A the measurement uncertainty is ±0.02 in whereas in FIG. 3B the measurement uncertainty is ±0.20 in. Accordingly, the fractional uncertainty in FIG. 3A, as shown in FIG. 3C, is about 5% (e.g., 2s/x̅=(0.02/0.395)) whereas the fractional uncertainty in FIG. 3B, as shown in FIG. 3D, is about 50% (e.g., 2s/x̅=(0.20/0.395)). The measurement result and measurement uncertainty shown in the user interface of FIG. 3A may indicate a high precision scenario (e.g., a fractional uncertainty of no greater than 10% in the example FIG. 3C) where the N measurements share very similar values. The measurement result and measurement uncertainty shown in the user interface of FIG. 3B may indicate a low precision scenario (e.g., a fractional uncertainty of greater than 10% in the example of FIG. 3D) where the N measurements values are more dissimilar from one another.

In some embodiments of the user interface, the fractional uncertainty may be displayed in addition to the measurement result and measurement uncertainty values. For example, the user interface of FIGS. 3A and 3C report the same measurement (x̅=0.395) and measurement uncertainty (±2s=±0.02) values. FIG. 3C also displays and indicator 316 including the fractional uncertainty value (2s/x̅=(0.02/0.395)≈5%). Likewise, the user interface of FIGS. 3B and 3D report the same measurement result (x̅=0.395) and measurement uncertainty (±2s=±0.20) values. FIG. 3D also displays an indicator including fractional uncertainty value (2s/x̅=(0.20/0.395)≈50%).

The user interface may display an uncertainty threshold. The uncertainty threshold may assist the user in quickly identifying whether a given measurement uncertainty represents a high precision or low precision scenario. For example, each of FIGS. 3C and 3D display the indicator includes a defined uncertainty threshold and an indicator of whether the measurement fractional uncertainty is greater than or less than a defined uncertainty threshold. In the embodiment of FIG. 3C, the checkmark symbol indicates that the displayed measurement fractional uncertainty (e.g., the fractional uncertainty of 5%) is less than the uncertainty threshold of 10%. Thus, a user is provided with visual confirmation that the measurement uncertainty is less than the uncertainty threshold, indicating a high precision measurement result. In the embodiment of FIG. 3D, the x symbol indicates that the displayed measurement fractional uncertainty (e.g., the fractional uncertainty of 50%) is greater than the uncertainty threshold of 10%. Thus, a user is provided with visual confirmation that the measurement uncertainty is greater than the uncertainty threshold, indicating a low precision measurement result.

When the measurement result and measurement uncertainty indicate a high precision (e.g., as in FIGS. 3A and 3C) scenario, the NDT system (e.g., the control circuit) may store the collected measurement data, including the determined measurement value and measurement uncertainty, in memory and correlate it to the corresponding test location ID (e.g., ID 32). When a high precision scenario occurs, subsequent automated actions may include confirming the measurement as valid, advancing to the next test location, updating inspection logs, or generating a report for asset management. The system may also indicate to the operator that the measurement meets the quality criteria and no further action is required at this location.

When the measurement result and uncertainty indicate a low precision scenario (e.g., as in FIGS. 3B and 3D), the NDT system (e.g., the control circuit) may cause the user interface to prompt the operator to consider or adjust aspects of the measurement process. Prompts may include reviewing couplant application, probe type or orientation, cable integrity, device settings (e.g., gain, gating), test piece surface conditions, or environmental conditions. Other automated actions based on a low precision scenario may include recommending the reacquisition of measurements, suggesting parameter adjustments, or flagging the location for further review or follow-up inspection.

When an operator returns to retest a test object at a previously inspected location (e.g., such as six months after the initial inspection) the NDT system may retrieve and display a prior measurement result, including the previously determined measurement uncertainty. This stored result, correlated to the specific test location identifier, provides valuable historical context for interpreting new measurements. The control circuit may cause the user interface to present both the current and prior measurement results and measurement uncertainties, enabling the operator to directly compare the precision and repeatability of the measurements over time.

If a previous set of measurements represents a high precision scenario (for example, as illustrated in FIGS. 3A and 3C) and a new measurement at the same location exhibits low precision, several factors may be responsible. Changes in environmental conditions (e.g., temperature, humidity, or surface contamination) may affect the measurement process. The test piece itself may have undergone physical changes, such as irregular wall thinning due to corrosion or pitting, which can introduce variability. Differences in the measurement process or components (e.g., probe type, orientation, or couplant application) may also contribute to reduced precision. Additionally, the probe may have been positioned at a slightly different location on the test piece in either the current or previous inspection, leading to inconsistent results when comparing the two sets of measurements. In such cases, the control circuit may cause the user interface to display indications or prompts alerting the operator to these possible causes and recommending further investigation or adjustment.

If both the previous and new measurements at a location exhibit high precision, this can suggest that the measurement process is repeatable and the test location conditions are stable. For example, the test piece may be experiencing no wall thinning or regular erosion, resulting in a relatively smooth and consistent interface. The control circuit may indicate to the operator that the measurement process and test location are reliable and may prompt the operator to proceed to the next inspection point or store the results for future reference.

If a previous measurement result indicates a low precision scenario (for example, as illustrated in FIGS. 3B and 3D) and a new measurement result also exhibits low precision, this may indicate persistent variability in environmental or test piece conditions. Irregular wall thinning, such as corrosion or pitting, may continue to affect the measurement results, or the measurement process may not have been sufficiently optimized. The control circuit may prompt the operator to consider additional adjustments, such as refining the measurement technique, improving probe placement, or addressing surface conditions.

If a new measurement result at a location previously characterized by low precision now exhibits high precision, this may be due to improvements in the measurement process, repositioning of the probe to a different test location, or changes in the test piece at the original test location. The control circuit may display indications of improved precision and suggest that the measurement process or test location wall thickness has stabilized and/or prompt the user to confirm that the test location is the same as that sampled by the previous inspection results attached to that specific test location ID.

By gathering multiple thickness or flaw depth measurements at a given test location and conducting a statistical analysis on the results, the NDT system can provide real-time feedback to users regarding environmental conditions, test piece conditions, and the repeatability of their measurement process. The control circuit may cause the user interface to display contextual indications, such as graphical comparisons of current and prior uncertainties, prompts for further action, or recommendations for process optimization. This statistical analysis not only supports informed decision-making during the inspection but also provides useful context to future inspectors revisiting previous inspection locations after long periods of time, thereby enhancing the asset management process and the long-term asset reliability assessment.

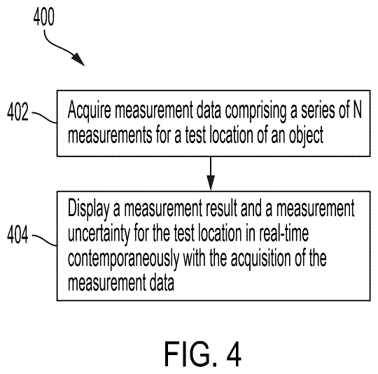

FIG. 4 illustrates a flowchart of a method 400 of non-destructive testing. The method may be performed by any of the NDT system embodiments disclosed herein. According to the method, a sensor of an NDT device acquires 402 measurement data for a test location of an object. The measurement data may comprise a series of N measurements. A user interface of the NDT device displays 404 a measurement result and a measurement uncertainty for the test location. The measurement result and measurement uncertainty are displayed in real-time, contemporaneously with the acquisition of the measurement data.

According to various embodiments of the method, a control circuit communicably coupled to the NDT device may process the measurement data to derive N measurement values for the test location. The control circuit may determine a sample mean and a sample standard deviation from the N measurement values and may generate the measurement result and the measurement uncertainty based on the sample mean and sample standard deviation.

According to various embodiments of the method, prior to the measurement data acquisition, the user interface of the NDT device may receive a selection of an uncertainty threshold. The method may further include automatically implementing, by the NDT device, an action based on the measurement uncertainty satisfying the uncertainty threshold.

According to various embodiments of the method, the control circuit may determine a fractional uncertainty value by calculating a ratio of a multiple of the sample standard deviation to the sample mean. The fractional uncertainty may be compared to the uncertainty threshold.

According to various embodiments of the method, the user interface may automatically display a prompt to re-acquire the measurement data for the test location based on the measurement uncertainty satisfying the uncertainty threshold.

According to various embodiments of the method, the user interface may automatically display a prompt for adjusting one or more measurement parameters based on the measurement uncertainty satisfying the uncertainty threshold. The one or more measurement parameters may include any one or more of a sensor or probe type, couplant application, or NDT device gates, timing parameters, gain, or excitation level.

According to various embodiments of the method, the NDT device may automatically transition to an acquisition state for acquiring measurement data for a next test location of the object based on the measurement uncertainty satisfying the uncertainty threshold.

According to various embodiments of the method, the NDT device may automatically reposition a robot to a next test location of the object based on the measurement uncertainty satisfying the uncertainty threshold. For example, the robot may be used to reposition the sensor to the next test location for acquiring a next series of N measurements.

According to various embodiments of the method, the control circuit may exclude invalid measurement values from the determination of the sample mean and sample standard deviation. The user interface may automatically exclude the invalid measurement value(s) or allow the user to manually identify and exclude the invalid measurement value(s).

According to various embodiments of the method, the user interface may display a graphical representation of a distribution of the N measurement values. The graphical representation may include at least one of a histogram or a probability density curve, where the histogram may summarize the distribution of the individual measurements and the probability density curve is parameterized by the calculated sample mean and sample standard deviation.

According to various embodiments of the method, a memory coupled to the NDT device may store the plurality of N measurement values, the measurement result, the measurement uncertainty, and/or metadata including device control settings and a test location identifier. The metadata may include a user annotation for at least one measurement value selected via the user interface.

According to various embodiments of the method, the control circuit may compare the measurement result and measurement uncertainty for the test location to a previously stored measurement result and measurement uncertainty for the same test location. The user interface may indicate that the measurement uncertainty exceeds the previously stored measurement uncertainty. The control circuit may automatically flag the location for further review, generate a report highlighting significant changes, and/or prompt the operator to retest the location. The NDT device may update maintenance schedules and/or automatically notify an asset management system if a trend of increasing uncertainty or material change is detected.

According to various embodiments, a remote server may be communicably coupled to the NDT device via a network including the control circuit. Thus, various processes performed by the control circuit may be performed by a server that is positioned remote from the NDT device sensor (e.g., at a remote compute facility).

According to various embodiments, the measurement result defines a property of the object at the test location. The property may include any one or more of a material thickness, a flaw depth, a crack length, a porosity level, a corrosion loss, a surface hardness, or a signal attenuation metric.

According to various embodiments of the method, the user interface of the NDT device may prompt removal and reapplication of a probe of the NDT device between successive acquisitions of the measurement data for the series of N measurements. For example, the user interface may display a message with instructions for lifting and reapplying the probe before the next measurement. The user interface may provide a visual indicator or countdown timer to guide the operator through the acquisition process.

According to various embodiments, the NDT device may include a digital thickness gauge. For example, the digital thickness gauge may integrate the sensor, control circuit, user interface, and memory in a portable, hand-held instrument. The device may be configured for field use, with an enclosure, intuitive controls, and/or the ability to store and export measurement data and statistical results for later analysis or reporting.

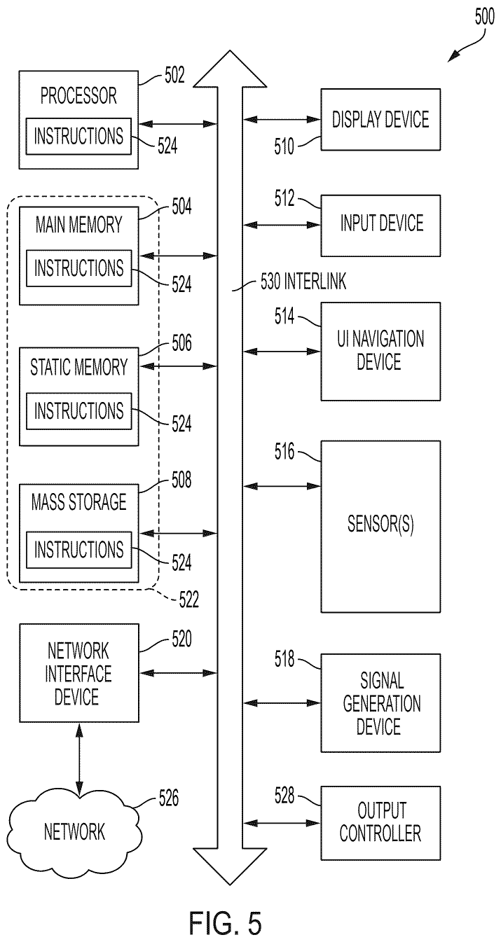

FIG. 5 illustrates a block diagram of an example comprising a machine 500 upon which any one or more of the techniques (e.g., methodologies) discussed herein may be performed. The machine (e.g., computer system) may include a hardware processor 502 (e.g., a central processing unit (CPU), a graphics processing unit (GPU), a hardware processor core, or any combination thereof), a main memory 504 and a static memory 506, connected via an interlink 530 (e.g., link or bus), as some or all of these components may constitute hardware for systems or related implementations discussed above.

Generally, the hardware processor may, for example, include at least one of a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a Neuromorphic Processor, a Quantum Processor, or any combination thereof. A processor circuit may further be a multi-core processor having two or more independent processors (sometimes referred to as “cores”) that may execute instructions contemporaneously. Multi-core processors contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently. A processor circuit may be emulated in software, running on a physical processor as a virtual processor or virtual circuit. The virtual processor may behave like an independent processor but is implemented in software rather than hardware.

Specific examples of main memory include Random Access Memory (RAM) and semiconductor memory devices, which may include storage locations in semiconductors such as registers. Specific examples of static memory include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; or optical media such as CD-ROM and DVD-ROM disks.

The machine may further include a display device 510, an input device 512 (e.g., a keyboard), and a user interface (UI) navigation device 514 (e.g., a mouse). In an example, the display device, input device, and UI navigation device may be a touch-screen display. The machine may include a mass storage device 508 (e.g., drive unit), a signal generation device 518 (e.g., a speaker), a network interface device 520, and one or more sensors 516, such as a global positioning system (GPS) sensor, compass, accelerometer, or some other sensor. The machine may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The mass storage device may comprise a machine-readable medium 522 on which is stored one or more sets of data structures or instructions 524 (e.g., software) embodying or utilized by any one or more of the techniques or functions described herein. The instructions may also reside, completely or at least partially, within the main memory, within static memory, or within the hardware processor during execution thereof by the machine. In an example, one or any combination of the hardware processor, the main memory, the static memory, or the mass storage device comprises a machine-readable medium.

Specific examples of machine-readable media include one or more of non-volatile memory, such as semiconductor memory devices (e.g., EPROM or EEPROM) and flash memory devices; magnetic disks, such as internal hard disks and removable disks; magneto-optical disks; RAM; or optical media such as CD-ROM and DVD-ROM disks. While the machine-readable medium is illustrated as a single medium, the term “machine readable medium” may include a single medium or multiple media (e.g., a centralized or distributed database, or associated caches and servers) configured to store the one or more instructions.

An apparatus of the machine includes one or more of a hardware processor (e.g., a central processing unit (CPU), a graphics processing unit (GPU), a hardware processor core, or any combination thereof), a main memory and a static memory, sensors, a network interface device, antennas, a display device, an input device, a UI navigation device, a mass storage device, instructions, a signal generation device, or an output controller. The apparatus may be configured to perform one or more of the methods or operations disclosed herein.

The term “machine readable medium” includes, for example, any medium that is capable of storing, encoding, or carrying instructions for execution by the machine and that cause the machine to perform any one or more of the techniques of the present disclosure or causes another apparatus or system to perform any one or more of the techniques, or that is capable of storing, encoding or carrying data structures used by or associated with such instructions. Non-limiting machine-readable medium examples include solid-state memories, optical media, or magnetic media. Specific examples of machine-readable media include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); or optical media such as CD-ROM and DVD-ROM disks. In some examples, machine readable media includes non-transitory machine-readable media. In some examples, machine readable media includes machine readable media that is not a transitory propagating signal.

The instructions may be transmitted or received, for example, over a communications network using a transmission medium via the network interface device utilizing any one of a number of transfer protocols (e.g., frame relay, internet protocol (IP), transmission control protocol (TCP), user datagram protocol (UDP), hypertext transfer protocol (HTTP), etc.). Example communication networks include a local area network (LAN), a wide area network (WAN), a packet data network (e.g., the Internet), mobile telephone networks (e.g., cellular networks), Plain Old Telephone (POTS) networks, wireless data networks (e.g., Institute of Electrical and Electronics Engineers (IEEE) 802.11 family of standards known as Wi-Fi®), a IEEE 802.15.4 family of standards, a Long Term Evolution (LTE) 4G or 5G family of standards, a Universal Mobile Telecommunications System (UMTS) family of standards, peer-to-peer (P2P) networks, and satellite communication networks, among others.

In an example, the network interface device includes one or more physical jacks (e.g., Ethernet, coaxial, or other interconnection) or one or more antennas to access the communications network. In an example, the network interface device includes one or more antennas to wirelessly communicate using at least one of single-input multiple-output (SIMO), multiple-input multiple-output (MIMO), or multiple-input single-output (MISO) techniques. In some examples, the network interface device wirelessly communicates using Multiple User MIMO techniques. The term “transmission medium” shall be taken to include any intangible medium that is capable of storing, encoding or carrying instructions for execution by the machine, and includes digital or analog communication signals or any other intangible medium able to facilitate communication of such software.

The terms “control circuit” and “controller” are substitutable with each other and encompass hardwired circuitry, programmable logic (such as microprocessors, microcontrollers, digital signal processors (DSPs), programmable logic devices (PLDs), programmable gate arrays (PGAs), or field-programmable gate arrays (FPGAs)), state machines, or firmware that executes stored instructions. Control circuits may be part of larger systems, such as integrated circuits (ICs), application-specific integrated circuits (ASICs), or systems-on-chips (SoCs), and may be found in devices such as computers, smartphones, wearable devices, and servers. These circuits may perform tasks involving data processing, communication, or data storage. Depicted components, functions, or operations may be implemented using hardware, software, firmware, or combinations of two or more thereof.

Instructions for implementing system features may be stored in various types of memory. Suitable memory may include dynamic random-access memory (DRAM), flash memory, and/or cache. These instructions may be distributed over a network or via other computer-readable media. The term “non-transitory computer-readable medium” refers to any physical medium capable of storing or transmitting instructions or information that may be read by a machine. Examples of suitable media include RAM, ROM, EPROM, EEPROM, magnetic or optical media, flash memory, or even propagated signals such as carrier waves or infrared signals.

In some embodiments, the control circuit may utilize machine learning (ML) techniques to make decisions based on sensor inputs or other data. Suitable ML methods may include supervised learning (with labeled inputs and outputs), unsupervised learning (for identifying patterns), or reinforcement learning (where the system adapts based on feedback). Suitable tasks for ML systems may involve classification, regression, clustering, anomaly detection, or optimization. ML may employ algorithms, such as decision trees, deep learning, support vector machines (SVMs), or neural networks, depending on the application. A suitable control circuit may incorporate a policy engine that applies specific rules based on equipment characteristics or environmental conditions. For instance, a neural network could process sensor data or operational inputs to determine appropriate actions. Techniques such as backpropagation or evolutionary strategies may be used to refine neural network parameters and optimize model selection for the given task.

In one embodiment, the control circuit (or controller) and system described herein may use machine learning to make determinations and to enable derivation-based learning outcomes. The system may communicate with a data collection system. The control circuit may learn from, model and make decisions/determinations on a set of data (including data provided by various sensors and data collection systems) by making data-driven predictions and adapting according to available data and modeling.

Machine learning may involve performing tasks using supervised learning, unsupervised learning, and reinforcement learning systems. Supervised learning may use one or more sets of example inputs and desired outputs with the machine learning systems, where unsupervised learning may use a learning algorithm that is structuring its input with, for example, pattern detection and/or feature learning. Reinforcement learning may perform in a dynamic environment and then provide feedback about correct and incorrect decisions. Machine learning may include tasks based on certain outputs. These tasks may be machine learning problems that can be addressed using mathematical and statistical techniques such as classification, regression, clustering, density estimation, dimensionality reduction, anomaly detection, and the like.

Suitable machine learning algorithmic types may include decision tree based learning, association rule learning, deep learning, artificial neural networks, genetic learning algorithms, inductive logic programming, support vector machines (SVMs), Bayesian networks, reinforcement learning, representation learning, rule-based machine learning, sparse dictionary learning, similarity and metric learning, learning classifier systems (LCS), logistic regression, random forest algorithms, K-means algorithms, gradient boost algorithms, K-nearest neighbors (KNN) algorithms, a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components are restricted to being integer-valued. Algorithms and machine learning techniques and systems may be used in computational intelligence systems, computer vision, Natural Language Processing (NLP), recommender systems, reinforcement learning, graphical models, and the like. In an example, machine learning may be used to perform determinations, calculations, comparisons and behavior analytics, and the like.

As mentioned above, the control circuit may include a policy engine. The policies the engine may apply may be based at least in part on characteristics of a given item of equipment or environment. For example, an artificial intelligence system, such as a neural network, may receive a number of environmental and task-related parameters as inputs. These parameters may include, for example, operational input of a given piece of equipment, data from various sensors, environmental information, location and/or position data, and the like. The neural network may be trained and may generate an output based on these inputs, with the output representing an action or sequence of actions that the equipment or system should take to accomplish the goal of the operation. Using a specific set of model parameters, the control circuit may process the inputs through the parameters of the neural network to generate a value (e.g., make a determination) at the output node designating that action as the desired action, activity, or operating state. An action may translate into a signal that causes the vehicle to operate in a particular manner. The control circuit may accomplish this via backpropagation, feed forward processes, closed loop feedback, or open loop feedback, for example. Alternatively, rather than using backpropagation, the control circuit may rely on a class of techniques known as evolution strategies to tune various parameters in the neural network. The control circuit may use neural network architectures that have a set of parameters representing weights that are applied to the various node connections. A number of copies of this network may be generated and adjustments to the parameters may be made with subsequent simulations. Once the outputs from the various models have been obtained, they may be evaluated on their performance using one or more success metrics. The best model or a “good enough” model may be selected, and the control circuit may execute that plan to achieve the desired input data to mirror the predicted ‘best outcome’ scenario. Additionally, the success metric itself may be a combination of the optimized outcomes, which may be weighted relative to each other. Success metrics may be dynamically established, and the process rerun and the equipment directions further modified.

In one embodiment, data may be generated, transmitted, and stored and may involve one or both of a protected space data source and an exposed space data source. The control circuit may encrypt and decrypt data as needed at rest, during use, or in transit. Encryption keys and schema may be selected and implemented as informed by end use parameters and requirements. The control circuit may evaluate and/or identify a decision boundary (that is, a boundary that separates desired behavior from undesired behavior) with regard to that data. If the control circuit determines that some quantity of data is from a protected space data source and/or is operating within determined boundaries then the control circuit, and the equipment being controlled, may operate normally. However, if the data is determined to be from an exposed space data source and/or it crosses the decision boundary, the control circuit may respond. Suitable responses may be to power down determined equipment, signal an alert, run a diagnostic routine, perform a data backup (without overwriting existing backup data), isolate equipment (including by suspending some or all communication pathways), and/or switch equipment or control operations to a safe mode of the control system, and/or initiate a safe mode state of the equipment (e.g., slow a vehicle to a safe and controlled stop). The safe mode may be, in one embodiment, a soft shutdown mode that is intended to avoid damage or injury based on the shutdown itself and in another embodiment may be a reboot and/or minimal reload of essential drivers and functionality.

Terms such as “processing,” “computing,” “calculating,” or “determining” refer to operations carried out by the control circuit, which may include computing systems or electronic devices that manipulate data represented as physical (electronic) quantities within memory or registers. One or more components may be described as “configured to,” “configurable to,” “operable/operative to,” “adapted/adaptable to,” or similar terms. Unless explicitly stated, these terms encompass components in both active and inactive states.

The above detailed description includes references to the accompanying drawings, which form a part of the detailed description. The drawings show, by way of illustration, specific embodiments in which the invention can be practiced. These embodiments are also referred to generally as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following aspects, the terms “including” and “comprising” are open-ended, that is, a system, device, article, composition, formulation, or process that includes elements in addition to those listed after such a term in a claim are still deemed to fall within the scope of that claim. Moreover, in the following aspects, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following aspects are hereby incorporated into the Detailed Description as examples or embodiments, with each aspect standing on its own as a separate embodiment, and it is contemplated that such embodiments can be combined with each other in various combinations or permutations.

What is claimed is:

1. A method of non-destructive testing, comprising:
acquiring, by a sensor of a non-destructive testing (NDT) device, measurement data comprising a series of N measurements at a test location of an object;
displaying, by a user interface of the NDT device, a measurement result and a measurement uncertainty for the test location, wherein the measurement result and measurement uncertainty are displayed in real-time contemporaneously with the acquisition of the measurement data.

2. The method of claim 1, comprising:
processing, by a control circuit, the measurement data to derive N measurement values for the test location;
determining, by the control circuit, a sample mean and a sample standard deviation from the N measurement values; and
generating, by the control circuit, the measurement result and the measurement uncertainty based on the sample mean and the sample standard deviation.

3. The method of claim 2, comprising:
receiving, by the user interface of the NDT device prior to the measurement data acquisition, a selection of an uncertainty threshold; and
automatically implementing, by the NDT device, an action based on the measurement uncertainty satisfying an uncertainty threshold.

4. The method of claim 2, comprising:
determining, by the control circuit, a fractional uncertainty value based on calculating a ratio of a multiple of the sample standard deviation to the sample mean, wherein the fractional uncertainty is compared to the uncertainty threshold.

5. The method of claim 3, comprising:
automatically displaying, by the user interface, a prompt to re-acquire the measurement data for the test location based on the measurement uncertainty satisfying the uncertainty threshold.

6. The method of claim 3, comprising:
automatically displaying, by the user interface, a prompt for adjusting one or more measurement parameters based on the measurement uncertainty satisfying the uncertainty threshold, the one or more measurement parameters comprising any one or more of a sensor or probe type, couplant application, or NDT device gating, timing, gain, or excitation level.

7. The method of claim 3, comprising:
automatically transitioning, by the NDT device, to an acquisition state for acquiring measurement data for a next test location of the object based on the measurement uncertainty satisfying the uncertainty threshold.

8. The method of claim 3, comprising:
automatically repositioning, by a robot, the NDT device to a next test location of the object based on the measurement uncertainty satisfying the uncertainty threshold.

9. The method of claim 2, comprising:
excluding, by the control circuit, invalid measurement values from the determination of the sample mean and sample standard deviation; and
identifying, by the user interface, the excluded measurement values.

10. The method of claim 2, comprising:
displaying, by the user interface, a graphical representation of a distribution of the N measurement values, the graphical representation comprising at least one of a histogram or a probability density curve, the probably density curve parameterized by the sample mean and sample standard deviation.

11. The method of claim 2, comprising:
storing, in a memory coupled to the NDT device, the plurality of N measurement values, the measurement result, the measurement uncertainty, and metadata including device control settings and a test location identifier.

12. The method of claim 11, wherein the metadata further comprises a user annotation for at least one measurement value selected via the user interface.

13. The method of claim 11, comprising:
comparing, by the control circuit, the measurement result and measurement uncertainty for the test location to a previously stored measurement result and measurement uncertainty for the same test location; and
indicating, by the user interface, whether the measurement uncertainty exceeds the previously stored measurement uncertainty.

14. The method of claim 1, wherein a remote server communicably coupled to the NDT device via a network comprises the control circuit.

15. The method of claim 1, wherein the measurement result defines a property of the object at the test location, and the property comprises any one or more of a material thickness, a flaw depth, a crack length, a porosity level, a corrosion loss, a surface hardness, or a signal attenuation metric.

16. The method of claim 1, comprising:
prompting, by the user interface of the NDT device, removal and reapplication of a probe of the NDT device between successive acquisitions of the measurement data for the series of N measurements.

17. The method of claim 1, wherein the NDT device comprises a digital thickness gauge.

18. A non-destructive testing (NDT) system, comprising:
a sensor configured to acquire measurement data for a test location of an object;
a control circuit communicably coupled to the sensor, the control circuit configured to:
obtain the measurement data from the sensor;
process the N data acquisitions to derive N measurement values for the test location;
determine a sample mean and a sample standard deviation from the N measurement values; and
generate a measurement result and a measurement uncertainty for the test location based on the sample mean and the sample standard deviation; and
a user interface configured to display the measurement result and the measurement uncertainty for the test location in real-time contemporaneously with the acquisition of the measurement data.

19. The NDT system of claim 18, wherein the control circuit is further configured to automatically implement an action based on the measurement uncertainty satisfying an uncertainty threshold, wherein the action comprises any one or more of:
displaying, via the user interface, a prompt to re-acquire the measurement data for the test location;
displaying, via the user interface, a prompt for adjusting one or more measurement parameters; or
transitioning the NDT device to an acquisition state for acquiring measurement data for a next test location of the object.

20. The NDT system of claim 18, further comprising a robot, wherein the control circuit is configured to automatically reposition the sensor to a next test location of the object based on the measurement uncertainty satisfying the uncertainty threshold.
